(19) United States
(12) Patent Application Publication
(10) Pub. No.: US 2006/0182415 A1
(43) Pub. Date: Aug. 17, 2006

(54) Recording Configuration of a Digital Information Carrier (Sound and Image) for Avoid Non-Authorized Copies

(76) Inventor: Ralf Richardson Da Silva, Sao Paulo - SP (BR)

Correspondence Address: SMITH HOPEN, PA, 180 PINE AVENUE NORTH, OLDSMAR, FL, 34677, US

(21) Appl. No.: 11/307,567

(22) Filed: Feb. 13, 2006

Related U.S. Application Data
(63) Continuation of application No. PCT/BR04/00151, filed on Aug. 13, 2004.

(30) Foreign Application Priority Data
Aug. 13, 2003 (BR) PI-0302893-3

(51) Int. Cl. H04N 5/91

(52) U.S. Cl. 386/94

(57) ABSTRACT

Recording configuration of a digital information carrier (sound and image) to avoid non-authorized copies, a recording configuration 1 related to sound/image digital information 2 recorded in optic discs 4 such as CD and DVD and the like and being able to be read in any reader equipment 1, comprising an optic disc 4 in which a recorded track portion 3 corresponds to a track portion A to be recorded from a set of whole tracks comprising the whole content B; the track portion A recorded in the track 3 has a customer final cost corresponding to the total cost of the whole content B. The configuration has been specially provided to reduce sound/image recording costs related to optic discs so as to reach a low customer final cost and eliminating problems caused by unlegal copies or non-authorized copies.

### CROSS REFERENCE TO RELATED APPLICATIONS

This application is a continuation of PCT Application No. PCT/BR04/000151, filed Aug. 13, 2004, which claims benefit of Brazilian Application No. BR PI-0302893-3, filed Aug. 13, 2003.

### BACKGROUND OF THE INVENTION

1. Field of the Invention

The present invention refers to a recording configuration of a digital information carrier (sound and image) to avoid unauthorized copies, particularly the present invention refers to a special configuration to reduce the cost of a sound/image recording in optic discs and to provide a final cost very reduced; the low cost of such optic disc will also reduce piracy and unauthorized copies.

2. Description of the Prior Art

It is known in the art that unauthorized copies is a problem which is increasing year after year. Professionals in the art, like optic disc producers, commonly draw the public attention to the image/sound piracy acting in music, films and games.

The last report of the IFPI (International Federation of the Phonographic Industry) informs that piracy has up to 50% (or more) of the music disc market in 25 countries in four continents, Brazil included in.

Such report raises an appeal to national governments to make efforts against piracy because CD piracy is bad to local cultures, it encourages criminal organizations and enhances unemployment.

Recently, a federal law has been issued to obligate DC, cassettes copies and the like to have digital signals in the corresponding serial number in order to be legally marketed in Brazil. Such law has been enforced in Apr. 22, 2003 and make easy governmental inspecting operations and turns piracy more difficult.

Moreover, the digital signals and the serial number of CD batches are complemented by a set of criteria which are stated just to make government inspection operations more efficient.

Another measure which has been taken in the art comprised the insertion of a digital code to permit identification of the legal phonogram and the respective authors or authorized artists, permanently and in real time.

Therefore, the search in the state of the art has indicated some patent documents related to this matter and the solutions provided in the prior art, for example, the Brazilian document P10112805 referring to a method for protection against optic disc copies by employing the different capability profiles of the encoder associated to a laser beam recorder and the CD writers of the art. The copy disc from the CD writer will provide a CD reader with a corrupted file and/or error message.

Another document, the Brazilian document P10104458 refers to a protection against copies of digital compact discs (CD) based on the fact of the user can employ a CD-ROM unity to read a sound data from a disc and save such data in a computer file and afterwards such data can be copied. Therefore, errors are intentionally provoked in the CD, such errors are not detected in a sound equipment, but it will cause interferences when the sound data is to be extracted from the disc by a data reader.

Another Brazilian patent document, P10016182 refers to a digital sound compact disc protected against copies and to a method for its production, such as neither the original track run nor the protection capability activation depends on a special kind of equipment. A noise patterns is incorporated to the CD content by means of a superimposed record of certain correction symbols and/or signals, so the final result is an incorrect code recording and other not correct values. A common CD recorder of such CD will detect a value of noise as a not reversible error and will apply a hiding error to avoid the error output.

Generally, as stated above, the phonographic industries and other aim to provide means in the optic discs to impeach unauthorized copies by damaging to the copies or blocking its recording.

However, in spite of all the above solutions, no suitable solution has been found, even most of the recording equipment reject the protected discs and it can cause damages to the optic reader.

Another problem probably the big one, is that all these approachings imply additional costs to the phonographic industry and the other because expertise personnel is to be employed to provide novel solutions, novel recording equipment mechanisms etc. which turns the final expensive. Such costs do not include government fees.

By the other hand, the piracy products industry grows up freely because it provides a low cost product, but without any technical quality which may cause the damage of the image/sound equipment.

Furthermore, unlegal products are not charged by official fees, do not pay copyrights, etc, they are not part of the production chain of the legal product, reaching quickly the market necessities, i.e., provide a similar product with a very low final cost.

In the same chain, in the end, is placed the customer who, in most developing countries (where the unlegal market is more enhanced) aims products with a low cost (games, CD etc.) and stimulating unfair practices and closing the piracy circle.

### SUMMARY OF THE INVENTION

In view of the above, the present invention particularly provides a solution to the artists class, the most interested party in this matter which comprises a novel configuration to the final product (ready to sell) with a cost which is lower that the piracy product price, i.e., a solution to the more complicate variable of this problem.

Based on statistics data from the phonographic industry, when an optic disc is issued, e.g., single singers, duets or bands, it contains about 12-15 songs and certainly, two or three of such songs are to be freely shown to the market (radio and TV programs) for promotion purposes.

Accordingly, the fans buy the CD (or DVD) in view of the good impact of the freely shown songs.

Therefore, the present invention comprises a novel recording configuration containing digital information provided in modules, i.e., a CD or DVD containing 12 songs is provided in order to match any configuration of a sound/image data reader equipment and containing two or three songs, preferably those songs to be freely shown.

So the novel recording configuration permits a lower final cost when compared to the current cost, and it provides a very competitive market price in view of the piracy products, but with many advantageous features because the technical quality of the legal copy and the reader equipment is thus preserved. Another feature is the customer warranty provided by legal products.

Other advantageous feature of the present invention is the maintenance of the legal commerce network, i.e., all rights are legally preserved and the author has a means to control the production and sales, the phonographic industry is able to control and to enhance its sale capability and the government collects and controls the respective fees.

### BRIEF DESCRIPTION OF THE DRAWINGS

With regard to the above description which is directed to the preferred embodiments, a set of drawings is provided wherein:

FIG. 1 illustrates a diagram in which a novel recording configuration is shown indicating all involved parts;

FIG. 2 illustrates a preferred embodiment of the novel recording configuration;

FIG. 3 illustrates certain way of storing the novel recording configuration.

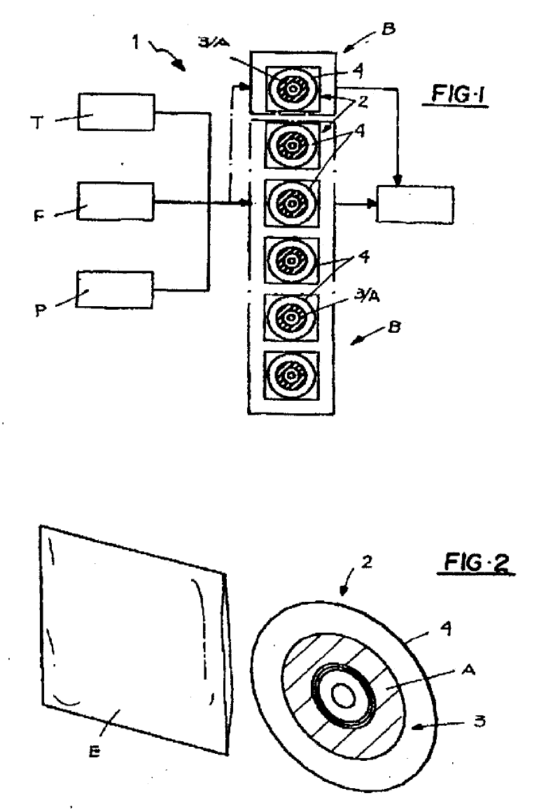

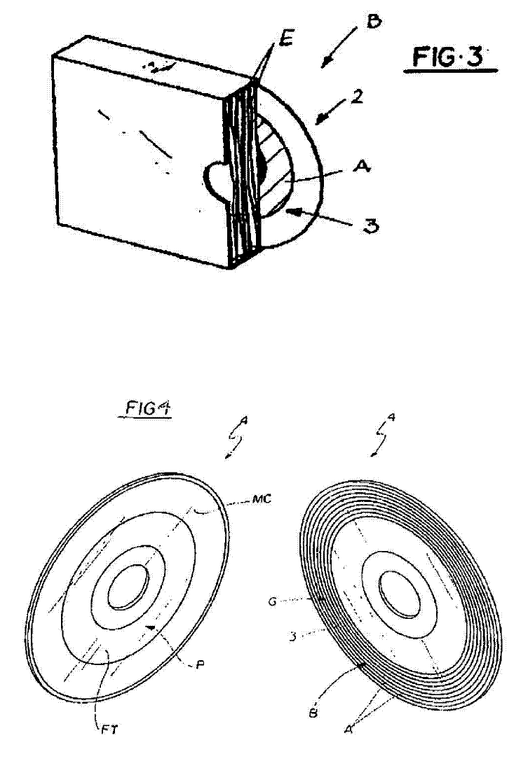

### BRIEF DESCRIPTION OF THE INVETION

Referring to the drawings, the present invention refers to a recording configuration of a digital information carrier (sound and image) to avoid non-authorized copies, a novel configuration 1 of a set of digital information 2 related to image/sound are recorded in an optic disc 4—CD and/or DVD or the like—which is able to be read in a sound/image equipment and involving a legal commerce network from the author T, the phonographic industry F or the like, fees and taxes P and the customers C, the configuration 1 is provided in such a manner that the optic disc 4 has a recorded track portion 3 corresponding to a part of track recording A from a total set of tracks comprising the whole disc content.

The track portion 3 containing part of the track A of the optic disc 4 and in accordance to the configuration 1 can be configurated as a module B or it can be configurated as the whole disc content if such content comprises a disc 4 having recorded tracks A of digital information 2.

Accordingly, the disc 4 having part of the tracks A recorded in the track portion 3 comprises a final cost which corresponds to a part of the total cost, and it permits a customer final cost significantly lower when it is compared to the current costs.

One of the advantages of the present invention is that the customer can buy other optic discs 4 having different track arrangements A which can be made public or not, and the whole content can be completed step by step.

The CD or DVD permits a tracking configuration provided by several peripheral configurations, from circular configuration to other, but being fitted to any reader equipment.

Envelopes E can be provided, but other kind of housing can define a receptacle to separately (or not) store the data, thus forming the whole content.

Further, the present invention comprises a recording configuration in which a set of digital information related to sound and/or image in a optic disc 4 such as a CD/CDR, DVD/DVDR discs or the like which are able to be read in any reader equipment and the optic disc 4 having a recorded track portion 3 corresponding to at least one sound/image recorded track A from a whole content B; the optic disc 4 having the following features:

a technical disclosure FT of the optic disc 4 (sound/image) such as CD/CDR; DVD/DVDR, the technical report is printed P or recorded G in a track in addition to sound and image tracks; and

the optic disc has a transparent look or is coated by metallized colour films MC

The present invention has been described in terms of it preferred embodiments, but they do not intend to limit the scope of the instant invention; such terms and different embodiments to be applied are considered as in the scope defined in the appending claims.

What is claimed is:

1. Recording configuration of a digital information carrier (sound and image) to avoid non-authorized copies, a recorded configuration 1 related to image/sound digital information 2 recorded in optic discs 4 such as CD and DVD and the like and being able to be read in any reader equipment 1 comprising an optic disc 4 in which a recorded track portion 3 corresponds to a track portion A to be recorded from a set of whole tracks comprising the whole content B; the track portion A recorded in the track 3 has a customer final cost corresponding to the total cost of the whole content B.

2. Configuration, according to claim 1, wherein the recorded track portion 3 containing the track portion A of the optic disc 4 as defined as a module of the whole content B.

3. Configuration, according to claim 1, wherein the recorded track portion 3 containing the track portion A of the optic disc 4 as defined as the whole content.

4. Configuration, according to any preceeding claims, wherein the disc 4 corresponding to the recording configuration 1 is provided in several peripheral configurations in such a manner that they can be fitted to any reader sound/image equipment.

5. Configuration, according to any preceeding claims, wherein the disc 4 is housed in envolopes E or any other housing form comprising a receptacle to separately, or not, data storing and completing the whole content.

6. Configuration, according to claim 1, comprising a set of digital information related to sound and or to image in an optic disc 4 such as CD/CDR; DVD/DVDR discs or the like which are able to be read in any reader equipment and the optic disc 4 having a recorded track portion 3 corresponding to a least one sound/image recorded track A from a whole content B; the optic disc 4 having the followings features:
a) a technical disclosure FT of the optic disc 4 (sound/image) such as CD/CDR; DVD/DVDR the technical report is printed P or recorded G in a track in addition to sound and image tracks; and
b) the optic disc has a transparent look or is coated by metallized colour films MC.
